(19) United States
(12) Patent Application Publication
(10) Pub. No.: US 2018/0157315 A1
(43) Pub. Date: Jun. 7, 2018

(54) SYSTEM AND METHOD FOR PROACTIVE POWER AND PERFORMANCE MANAGEMENT OF A WORKLOAD IN A PORTABLE COMPUTING DEVICE

(71) Applicant: QUALCOMM INCORPORATED, SAN DIEGO, CA (US)

(72) Inventors: NAVID EHSAN, SAN DIEGO, CA (US); MICHAEL SPARTZ, POWAY, CA (US); IDREAS MIR, SAN DIEGO, CA (US); JON ANDERSON, BOULDER, CO (US); RONALD ALTON, OCEANSIDE, CA (US); RAJIV VIJAYAKUMAR, SAN DIEGO, CA (US)

(21) Appl. No.: 15/399,677

(22) Filed: Jan. 5, 2017

Related U.S. Application Data
(60) Provisional application No. 62/428,675, filed on Dec. 1, 2016.

(51) Int. Cl. G06F 1/32; G06N 99/00

(52) U.S. Cl. CPC G06F 1/3296; G06N 99/005; G06F 1/3206

(57) ABSTRACT

Disclosed are methods and systems for proactive power and performance management of workloads in a portable computing device (“PCD”), such as, but not limited to, a virtual reality (“VR”) or augmented reality (“AR”) workload. An exemplary embodiment determines that a target application (or an application queued for execution) is compatible with a proactive throttling policy. Advantageously, for those applications that are compatible with a proactive throttling policy, embodiments of the solution may rely on historical performance data of those applications to preset performance parameters such that the PCD may deliver a consistent user experience over time uninterrupted by fluctuations in processing performance resulting from reactive thermal throttling policies.

### PRIORITY AND RELATED APPLICATIONS STATEMENT

This application claims priority under 35 U.S.C. § 119(e) and is a non-provisional of U.S. Provisional Patent Application Ser. No. 62/428,675, filed on Dec. 1, 2016 and entitled, “SYSTEM AND METHOD FOR PROACTIVE POWER AND PERFORMANCE MANAGEMENT OF A WORKLOAD IN A PORTABLE COMPUTING DEVICE,” the entire contents of which are hereby incorporated by reference.

### DESCRIPTION OF THE RELATED ART

Portable computing devices (“PCDs”) are becoming necessities for people on personal and professional levels. These devices may include cellular telephones, portable digital assistants (“PDAs”), portable game consoles, palmtop computers, and other portable electronic devices. PCD uses and functionality are as extensive as they are varied. For legacy frameworks in many PCDs, the constant introduction of new, bandwidth intensive applications continues to push the thermal performance limits.

The reality is that PCDs are typically limited in size and, therefore, room for components within a PCD often comes at a premium. As such, there rarely is enough space within a PCD for engineers and designers to mitigate thermal degradation or failure of processing components by using clever spatial arrangements or strategic placement of passive cooling components. And, PCDs typically do not have active cooling devices, like fans, which are often found in larger computing devices such as laptop and desktop computers. Therefore, current systems and methods rely on various temperature sensors and/or current sensors embedded on the PCD chip and elsewhere to monitor power usage and thermal energy dissipation and then use the measurements to reactively trigger application of thermal power management techniques that adjust workload allocations, processing speeds, etc. to reduce thermal energy generation.

Such reactive thermal power management techniques presently used in the art can be fatal to user perceived quality of service (“QoS”) when applied to certain use cases. For example, under a heavy processing workload associated with an immersive multimedia gaming use case (e.g., a virtual reality or augmented reality use case), current systems and methods throttle the voltage and frequency of multiple components to remain within an overall power budget that precludes excessive thermal energy generation. In doing so, the processing workload associated with the immersive multimedia gaming use case is not reduced but, rather, the speed at which the workload is processed is temporarily slowed. The inevitable result is that excessive thermal energy generation is avoided at the expense of the user experience (“Ux”) as measured in user perceived QoS. Indeed, in an immersive multimedia use case, fluctuations in processing bandwidth that causes frame drops and/or a reduced frame rate can give the user motion sickness.

It may be preferred to process an immersive multimedia workload (as well as other workload types within a PCD) at a lower performance level from the very start in order to avoid thermally triggered throttling. A somewhat slower yet consistent processing speed, which results in a consistent frame rate, may be desirable over a cyclically throttled maximum processing speed. As such, current systems and methods for mitigating excessive thermal energy generation by processing components in a PCD are inadequate when the PCD is subject to an immersive multimedia use case.

Therefore, what is needed in the art is a system and method for proactive power and performance management in a PCD. More specifically, what is needed in the art is a system and method that recognizes a workload as benefitting from a proactive throttling policy, such as an immersive multimedia workload, and then uses historical performance data for the workload in order to proactively throttle performance parameters such that the workload is not subject to reactive thermal throttling events and QoS is optimized.

### SUMMARY OF THE DISCLOSURE

Various embodiments of methods and systems for proactive power and performance management of a workload in a portable computing device (“PCD”), such as, but not limited to, a virtual reality (“VR”) or augmented reality (“AR”) workload, are disclosed. An exemplary embodiment determines that a first target application is compatible with a proactive throttling policy. Advantageously, for those applications that are compatible with a proactive throttling policy, embodiments of the solution may rely on historical performance data of those applications to preset performance parameters such that the PCD may deliver a consistent user experience uninterrupted by fluctuations in processing performance resulting from reactive thermal throttling policies.

When an active or queued application is identified as being suitable for execution according to a proactive throttling policy, the method may determine the active use case in the PCD to which the execution of the target application will be subject. With the target application and the active use case identified, the exemplary method may query a historical database for performance data associated with the target application when it was previously executed according to a previous use case that is similar to the identified active use case. Based on the historical data, which may include performance parameter settings of various processing components, power consumption rates, temperature readings, throttling actions taken, etc., the method may smartly, and proactively, adjust the performance settings and/or power supply limits under which the application will be executed so that reactive thermal mitigation measures may be avoided while the application is being executed.

As such, based on the queried performance data, the method may determine performance settings for one or more processing components, the optimal performance settings being determined in view of a goal to minimize thermally triggered throttling as explained above. The method then allows the target application to be executed subject to the determined performance settings. During execution, the method monitors the target application and its performance subject to the active use case. Subsequently, the historical database may be updated to include the newly monitored performance data for the target application when executed in association with the active use case. In this way, subsequent iterations of the method may fine tune the performance settings and thresholds based on more and/or better historical data in the database.

It is envisioned that the target application may be in the form of an immersive multimedia workload as such workloads may be processed to deliver optimal user experience when processing speed swings resulting from reactive throttling policies are avoided. For those applications where maximizing the amount of time that the workload is processed at a maximum speed is a more important factor for user experience than the number of times that thermal events cause throttling of processing speeds, the exemplary method may recognize as much and allow such applications to execute subject to a default throttling policy that adjusts performance settings for the one or more processing components in view of real-time thermal energy readings (i.e., a reactive throttling policy).

The active use (as well as historical use cases) case may be quantified based on thermal sensor readings, concurrent workloads, current sensor readings, etc. Performance settings that are proactively set or capped may be DCVS settings and/or performance parameters associated with the workload itself and/or a processing component (I.e., application level throttling) such as, but not limited to, eye buffer resolution, eye buffer MSAA, time warp CAC, eye buffer FPS, display FPS, time warp output resolution, textures LOD, 6DOF camera FPS, and fovea size.

### BRIEF DESCRIPTION OF THE DRAWINGS

In the drawings, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1 illustrates the coupling of a portable computing device (“PCD”) configured and programmed to render an immersive multimedia output with an exemplary virtual reality headset that enables a user to perceive the immersive multimedia output;

FIG. 2 illustrates the effect on frame rate when an immersive multimedia workload is processed subject to a reactive throttling approach versus being processed subject to a proactive throttling approach according to an embodiment of the solution;

FIG. 3 is a functional block diagram illustrating an embodiment of an on-chip system for implementing proactive power and performance management in a portable computing device (“PCD”);

FIG. 4 illustrates an exemplary record of adjustable performance settings and their relative impact on power consumption by exemplary processing components operating according to an immersive multimedia workload;

FIGS. 5A, 5B, 5C, and 5D illustrate exemplary profile graphs of an exemplary GPU processing component for a given immersive multimedia use case, each illustrating a relationship between a performance setting, user experience relative to the setting, and power consumption associated with the setting;

FIG. 6 depicts a logical flowchart illustrating a method for proactive power and performance management in a portable computing device (“PCD”) via consideration of historical performance data and requests for selective adjustments of component performance settings to avoid frame drops and/or detrimental frame rate reduction; and

FIG. 7 is a functional block diagram illustrating an exemplary, non-limiting aspect of the PCD of FIGS. 1 and 3 in the form of a wireless telephone for implementing methods and systems for proactive power and performance management.

### DETAILED DESCRIPTION

The word “exemplary” is used herein to mean “serving as an example, instance, or illustration.” Any aspect described herein as “exemplary” is not necessarily to be construed as exclusive, preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed. An “application” or “target application” may be, depending on the context, an application that benefits from a proactive throttling policy such as, but not limited to, an immersive multimedia application.

As used in this description, the terms “component,” “database,” “module,” “system,” “thermal energy generating component,” “processing component” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “central processing unit (“CPU”),” “digital signal processor (“DSP”),” “graphical processing unit (“GPU”),” and “chip” are used to refer to exemplary processing components that may be processing a workload according to one or more applications. Moreover, a CPU, DSP, GPU or a chip may be comprised of one or more distinct processing components generally referred to herein as “core(s).” Additionally, to the extent that a CPU, DSP, GPU, chip or core is a functional component within a PCD that consumes various levels of power to operate at various levels of functional efficiency, one of ordinary skill in the art will recognize that the use of these terms does not limit the application of the disclosed embodiments, or their equivalents, to the context of processing components within a PCD.

In this description, it will be understood that the terms “thermal” and “thermal energy” may be used in association with a device or component capable of generating or dissipating energy that can be measured in units of “temperature.” Consequently, it will further be understood that the term “temperature,” with reference to some standard value, envisions any measurement that may be indicative of the relative warmth, or absence of heat, of a “thermal energy” generating device or component. For example, the “temperature” of two components is the same when the two components are in “thermal” equilibrium.

In this description, the terms “workload,” “process load,” “process workload,” “use case workload,” “immersive multimedia workload,” “VR workload” and the like are often used interchangeably and generally directed toward the processing burden, or percentage of processing burden, associated with a given processing component(s) in a given embodiment.

In this description, the terms “thermal mitigation technique(s),” “thermal policies,” “thermal power management,” “thermal mitigation measure(s),” “throttling” and the like are used interchangeably. Notably, one of ordinary skill in the art will recognize that, depending on the particular context of use, any of the terms listed in this paragraph may serve to describe hardware and/or software operable to increase performance at the expense of thermal energy generation, decrease thermal energy generation at the expense of performance, or alternate between such goals. As will be better understood from a review of the entire disclosure, embodiments of the solution may leverage a proactive throttling approach, as opposed to a reactive throttling approach, to optimize the user experience for certain applications, such as immersive multimedia applications, while operating at or near the PCD thermal/power envelope limits.

In this description, the term “portable computing device” (“PCD”) is used to describe any device operating on a limited capacity power supply, such as a battery. Although battery operated PCDs have been in use for decades, technological advances in rechargeable batteries coupled with the advent of third generation (“3G”), fourth generation (“4G”) and fifth generation (“5G”) wireless technology have enabled numerous PCDs with multiple capabilities. Therefore, a PCD may be a cellular telephone, a satellite telephone, a pager, a PDA, a smartphone, a navigation device, a smartbook or reader, a media player, a combination of the aforementioned devices, a laptop computer with a wireless connection, among others.

The term “use case” is used herein to refer to an instantaneous state of PCD operation in delivering application functionality, such as an immersive multimedia functionality, to a user. Inevitably, an immersive multimedia use case is tied to the execution of one or more applications by a PCD, such as a virtual reality gaming application for example. As such, it will be understood that any given use case dictates that one or more components in a PCD are actively consuming power and delivering functionality. Notably, not all use cases require the same combination of active components and/or the same levels of power consumption by active components. Moreover, although a given use case may be largely defined by a single application in execution (such as an immersive multimedia gaming application), it will be understood that other applications unrelated to said single application may also be running and contributing to the aggregate power consumption and functionality of the use case.

In this description, the terms “immersive multimedia,” “virtual reality,” “augmented reality,” “VR,” and “AR” are used interchangeably to refer to applications executed by a PCD and experienced by a user when the PCD is coupled to a VR headset. Embodiments of the solution are described within the context of VR use cases, but such is not meant to suggest that user experience for VR-type use cases only may benefit from embodiments of the solution. Rather, embodiments of the solution envision any application running in a PCD that may benefit from a proactive throttling policy.

In this description, and as would be understood by one of ordinary skill in the art, the acronym MSAA stands for multi sample anti-aliasing, the acronym CAC stands for chromatic aberration correction, FPS stands for frames per second, DOF stands for degrees of freedom, and LOD stands for level of detail.

Minimizing excessive or detrimental thermal energy generation in a PCD executing a virtual reality application, without unnecessarily impacting quality of service (“QoS”), can be accomplished by monitoring processing component power consumption and/or one or more sensor measurements that correlate with chip temperatures and skin temperatures of the PCD. By closely monitoring the power consumption and temperature measurements, a proactive power and performance management solution in a PCD may rely on historical performance to systematically cap power settings of active processing components in an effort to optimize user experience without risking execution of thermal management techniques that could cause frame drops or frame rate reductions. Moreover, it is envisioned that certain embodiments may also selectively authorize adjustment of performance settings for a target application in order to reduce the likelihood that power demand spikes could trigger a reactive thermal management event.

Immersive multimedia applications, with their high processing bandwidth demands and need for consistent delivery of functionality to maintain QoS, provide a convenient context in which to describe advantages and aspects of a proactive power and performance management solution. Notably, however, it is envisioned that embodiments of the solution may be beneficial to applications other than immersive multimedia applications.

As one of ordinary skill in the art would understand, immersive multimedia applications require a low motion to photon latency (“m/pl”) in order to ensure a positive user experience. That is, a positive user experience in virtual reality gaming necessarily requires that the application respond quickly to the user's motion; otherwise, a perceptible delay in responding to the user's motion may cause the user to experience motion sickness. To be most effective, an immersive multimedia application must be capable of simulating real world visual feedback to a user's motion. For this reason, it is more important for an immersive multimedia system to process a workload efficiently than it is for it to maintain a visually rich output. That is, delivery of a consistent frame rate, even with a reduced quality visual output, is more desirable to user experience for an immersive multimedia application than a high quality visual output at a fluctuating frame rate.

In order to keep the m/pl sufficiently low, immersive multimedia applications in PCDs execute an asynchronous time warp workload that reacts to sensor inputs indicative of the user's motion and physical positioning (such as, but not necessarily limited to, accelerometer, gyroscope, and magnetometer readings). The asynchronous time warp workload is in addition to the underlying gaming workload and, as such, adds processing burden spikes to one or more of the camera, DSP, CPU and GPU. It is the asynchronous time warp workload that enables a VR application to reconcile the visual output rendered to the user by the game with the physical motion of the user. Consequently, and as would be understood by one of ordinary skill in the art, virtual reality applications require relatively more power consumption than non-VR gaming applications.

The increased power consumption requirements of immersive multimedia applications in PCDs makes those applications especially susceptible to thermal mitigation policies. The increased power consumption of a VR use case may lead to excessive thermal energy generation that, in turn, reactively triggers the application of thermal mitigation measures. As explained above, thermal mitigation measures may be extremely detrimental to user experience for a VR use case. Advantageously, embodiments of the solution seek to avoid the need for thermal mitigation during a VR use case by leveraging historical data to set limits on power consumption and adjust aspects of the VR-related workload that least affect user experience. In this way, embodiments of the solution may ensure delivery of a consistent frame rate that optimizes user experience with a low m/pl.

Essentially, embodiments of the solution seek to set use case parameters to avoid thermal mitigation measures in the PCD while delivering an optimized sustained performance. Advantageously, embodiments of the solution maintain a consistent performance over a relatively extended duration. To do so, embodiments seek to operate the PCD at, or below, the PCD's thermal/power envelope. Additionally, embodiments may accommodate temporary performance increases above the preset performance caps (preset in view of historical application performance) while ensuring that the historically sustainable average power consumption is maintained.

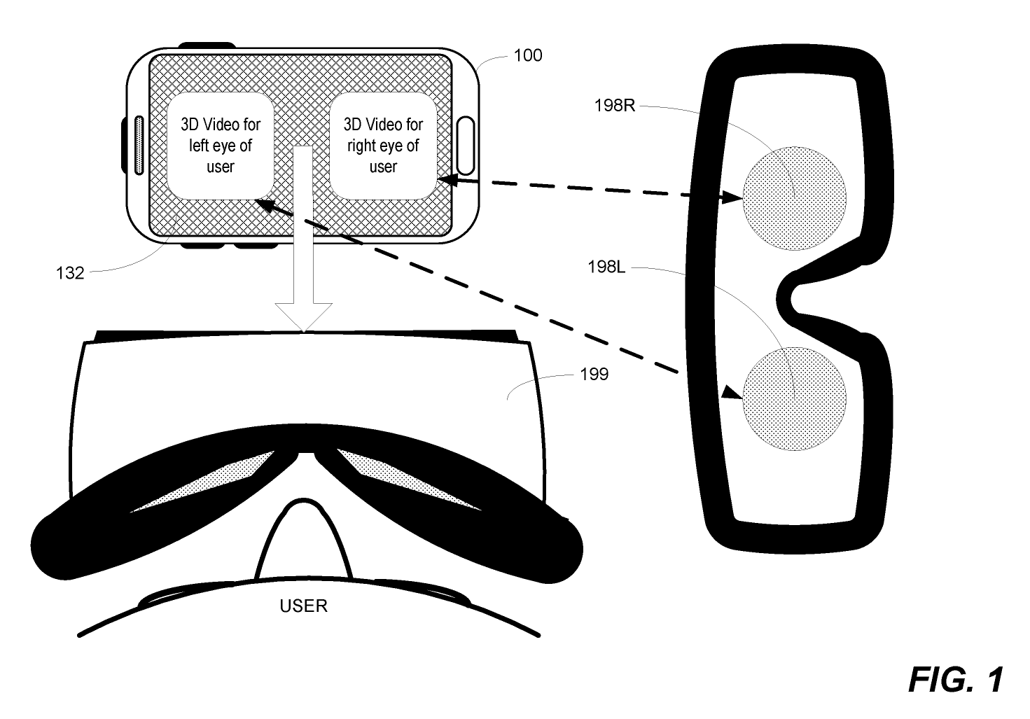

FIG. 1 illustrates the coupling of a portable computing device (“PCD”) 100 configured and programmed to render an immersive multimedia output with an exemplary virtual reality headset 199 that enables a user to perceive the immersive multimedia output. The headset 199 may have a set of left and right optical lenses 198 through which the user may visually experience a multimedia output rendered on the display 132 of the PCD 100. As one of ordinary skill in the art would understand, the display 132 may be juxtaposed and mechanically fixed to the front of the headset 199 (as indicated by the “arrow” in the FIG. 1 illustration) such that the multimedia output(s) are aligned with the left and right optical lenses 198.

With the headset 199 mounted to the user, and the PCD 100 mounted to the headset 199, motion of the user's head may be recognized by motion sensors in the PCD 100 and the multimedia output of the PCD 100 reconciled therewith. In some embodiments, the headset 199 may have integrated motion sensors that pair with the PCD 100 to provide data indicative of the user's movement. As described herein, excessive latency in providing and processing data indicative of the user's movement can lead to an unacceptable motion to photon latency (“m/pl”) that causes user discomfort when perceiving the immersive multimedia content.

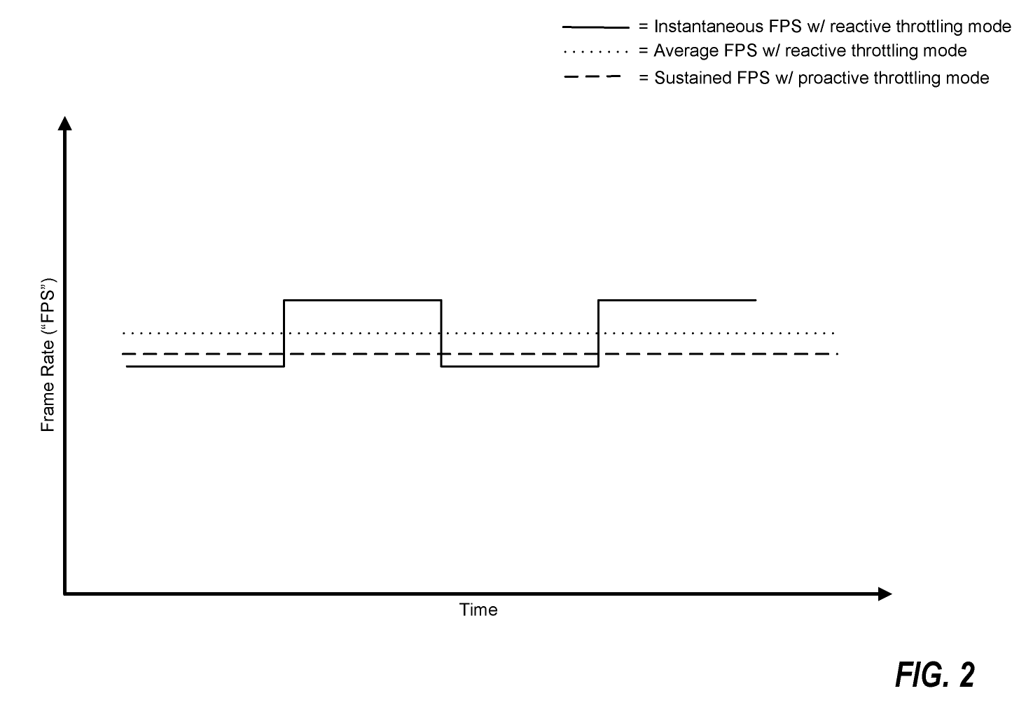

FIG. 2 illustrates the effect on frame rate when an immersive multimedia workload is processed subject to a reactive throttling approach versus being processed subject to a proactive throttling approach according to an embodiment of the solution. The solid line plot illustrates a typical instantaneous FPS in a PCD 100 processing a VR workload that is subject to reactive thermal throttling strategies. With the PCD defaulting to a maximum processing speed whenever allowed, excessive thermal energy generation causes throttling actions that reduce the processing speed until thermal energy is dissipated. Once dissipated, the processing speed is increased again. As a result, the FPS drops when the processing speed is reduced and increased when the processing speed is increased. While the average FPS may be optimized (dotted line plot), the swings in instantaneous FPS may have a huge detrimental impact on user experience.

Embodiments of the solution sacrifice the average FPS in order to avoid the need for thermal mitigation measures. In doing so, the average FPS delivered by embodiments of the solution may be relatively lower than maximum possible FPS, but the sustained and consistent delivery of an instantaneous FPS may be more optimal for maximizing user experience (dashed line plot).

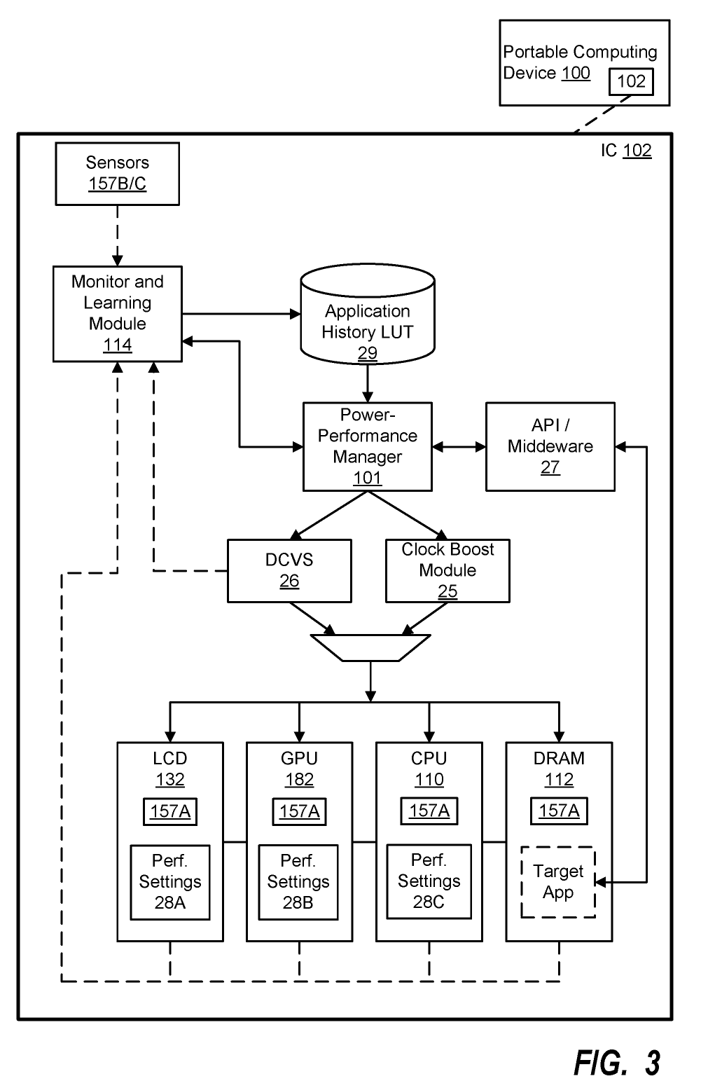

FIG. 3 is a functional block diagram illustrating an embodiment of an on-chip system 102 for implementing proactive power and performance management in a portable computing device (“PCD”) 100. The on-chip system 102 uses historical performance and thermal throttling data to adjust the maximum power set point for an application use case. The on-chip system 102 may also allow for temporary increases in performance and/or instantaneous power consumption for critical tasks (e.g., time warp workload in a VR application) with a goal to maintain the average power consumption beneath a thermal envelope limit. Further, depending on embodiment, the on-chip system 102 may interface with an application being executed by the on-chip system 102 to intelligently adjust component performance settings and visual output quality. In doing so, embodiments of the solution work to avoid thermal mitigation actions that could cause frame drops and/or detrimental frame rate reduction, preferring instead to ensure delivery of a consistent frame rate.

An active virtual reality application (shown stored in the DRAM 112) may be in execution by various processing components such as, but not necessarily limited to, the CPU 110, GPU 182 and LCD display 132. As would be understood by one of ordinary skill in the art, workloads associated with the target application may be processed by the processing components in order to generate an immersive multimedia output and user experience.

While the various processing components 110, 182, 132 are processing the various VR workloads, the monitor and learning (“M&L”) module 114 may be monitoring one or more sensors 157 and/or actions taken by a dynamic control and voltage scaling (“DCVS”) module 26. Sensors 157A, for example, may measure junction temperatures of the respective processing components 110, 182, 132. Sensors 157B and 157C, for example, may measure skin temperature of the PCD 100 (which may provide for inference of an ambient temperature) or power current levels on various power rails associated with the processing components 110, 182, 132. The power performance manager module 101 may provide the M&L module 114 with knowledge as to the particular target application in execution, its performance settings, and parameter settings. Advantageously, the M&L module 114 may couple data taken from the sensors 157 and DCVS module 26 with the target application identification to define a particular use case for the target application. The M&L module 114 may then store the use case data in the application history lookup table (“LUT”) 29.

While the target application is in execution, the power performance manager module 101 may allow for instantaneous power/processing surges to accommodate short term workloads such as time warping workloads associated with immersive multimedia applications. The short term processing increase requirements may be handled through a clock boost module 25, the output of which is multiplexed with the DCVS 26 requirements. Notably, the DCVS requirements may have been capped by the power performance manager 101 based on a review of historical performance data queried from LUT 29 at the time of execution for the target application.

If the DCVS requirements are capped too high, then thermal mitigation actions may be triggered such that the DCVS 26 throttles power supplied to the processing components 110, 182, 132. The M&L module 114 may recognize and record such thermal throttling events as well as clock boost events in a use case profile record stored/updated in the LUT 29. Multiple use case profiles for any given application may be recorded and stored in the LUT 29 by the M&L module 114. With knowledge of the power current settings, concurrent workloads, thermal energy levels, performance settings, thermal throttling events, clock boost requirements and the like stored in the LUT 29, the power performance manager module 101 may adjust the maximum allowable set points for the DCVS 26 the next time the target application is launched according to a similar use case. In this way, embodiments of the solution may, over time, iteratively adjust power supply thresholds such that thermal mitigation events are avoided and a consistent, sustained, optimized performance is achieved.

Additionally, in view of historical performance settings of the processing components 110, 182, 132 and the behavior of thermal mitigation, the power performance manager 101 may work with the target application to adjust the performance settings either “up” or “down” in an effort to modify the immersive multimedia workload. In so doing, the power-performance manager 101 may be able to allow for an increased visual quality without risking excessive thermal energy generation due to the increased workload. Alternatively, the power performance manager 101 may elect not to authorize increases in performance settings if it determines that the benefit to user experience would be minimal compared to the increased risk of a thermal event. Or, the power performance manager 101 may elect not to authorize increases in performance settings if it determines that the benefit to user experience would be better served by keeping visual output quality at reduced settings so that an increase in the maximum power supply through the DCVS 26 might be allocated for an increased FPS.

With the above in mind, when an application such as an immersive multimedia application is launched, the M&L module 114 may provide the power performance module 101 with power rail data and data taken from profile graphs stored in the LUT 29 and associated with various performance settings of the processing components 110, 182, 132. The power performance module 101 may then work to adjust the VR workload such that power consumption is reduced without having to reduce the maximum processing speeds allowed through the DCVS 26. To do so, the power performance module 101 may identify which of the processing components 110, 182, 132 is associated with a relatively high power consumption the last time the application was executed according to the present use case (may be determined from sensors 157 configured for measuring power levels on power rails respectively supplying power to the processing components 110, 182, 132) and then leverage the performance setting graph data to adjust those performance settings for the given processing component which reduce power consumption with the least impact on user experience.

Similarly, in some embodiments of the solution, the power performance module 101 may work with an application program interface (“API”) or middleware 27 to cause the active immersive multimedia application to adjust its workload requirements upstream from the processing components. In this way, frame drops and/or detrimental frame rate reduction may be avoided by adjusting the scope of the VR workload emanating from the target application instead of, as in other embodiments, adjusting the performance settings of the processing components to avoid processing strategic portions of the VR workload.

When querying the LUT 29, the M&L module 114 may look for records that most nearly approximate the active use case and, based on those records, work with the power performance manager 101 to intelligently adjust the maximum power settings allowed by the DCVS 26. In some embodiments, the M&L module 114 and the power performance manager 101 may also work together to intelligently adjust a VR workload such that user experience is optimized without risking thermal events that could lead to throttling actions by the DCVS 26. It is envisioned that some embodiments of the M&L module 114 may interpolate between records in order to derive the most useful and applicable data for proactively throttling the DCVS 26 and/or adjusting a VR workload. It is also envisioned that the M&L module 26 may work to recognize new use cases and the response of the system 102 to actions taken by the power performance module 101 and/or the DCVS module 26. Advantageously, the M&L module 114 may update the LUT 29 for future use and benefit of the power performance module 101 when the application next executes.

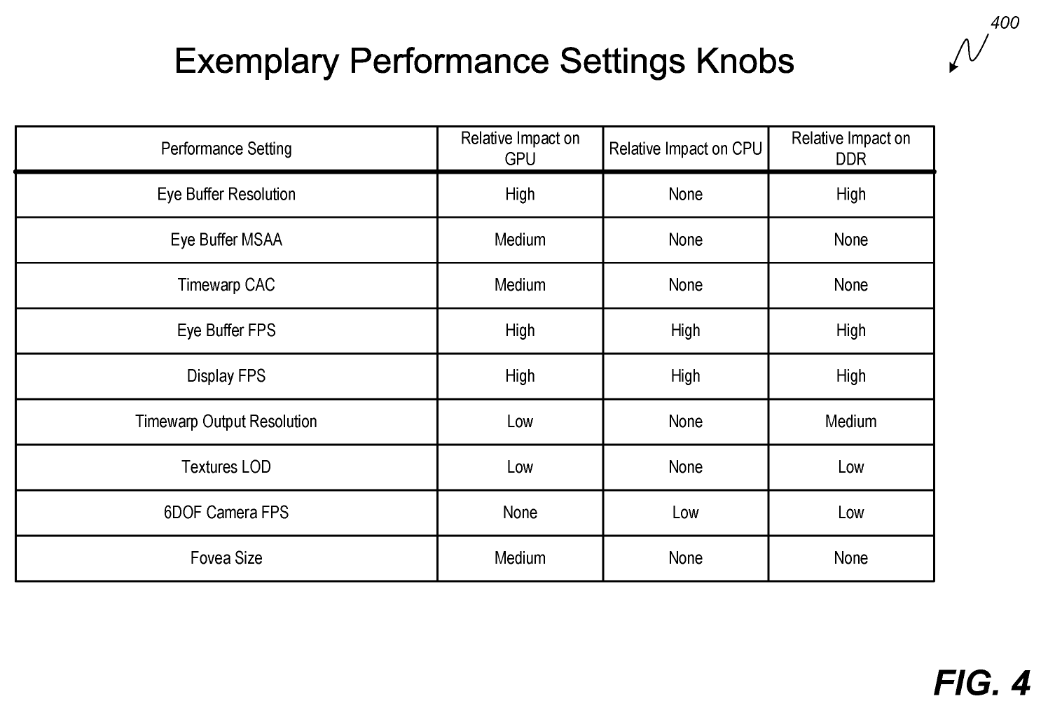

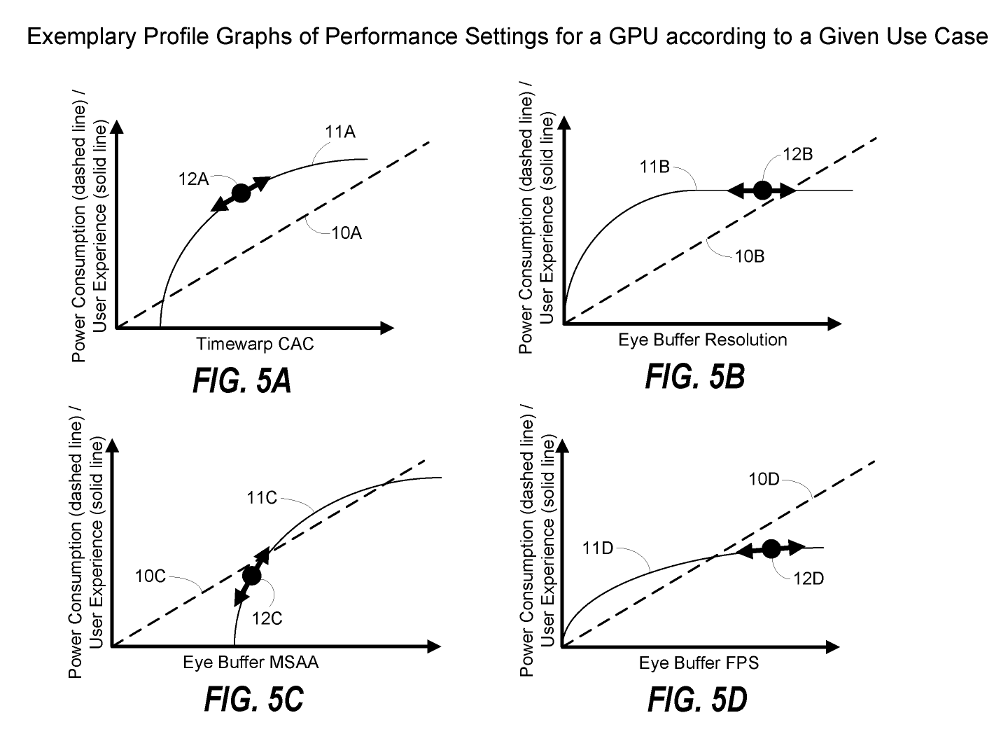

FIG. 4 illustrates an exemplary record of adjustable performance settings and their relative impact on power consumption by exemplary processing components operating according to an immersive multimedia workload. The exemplary record 400 may be stored in LUT 29 (which may be instantiated in some portion of memory 112) and queried by the power performance module 101 to determine which performance settings for which thermal aggressor 110, 182, 132, 112 may be adjusted for maximum beneficial impact on power consumption and least negative impact on user experience. As described above, the M&L module 114 may have monitored and stored performance settings of the various processing components when the target application was last executed according to a given use case. Depending on the nature and number of thermal throttling events that occurred when the target application was last executed according to the given use case, the power performance manager may adjust the maximum clock settings allowed by the DCVS 26 and/or adjust the performance settings of the one or more processing components 110, 182, 132, 112. If the power performance manager 101 determines to adjust the performance settings, data such as that illustrated in FIG. 4 and FIG. 5 may be utilized.

Returning to the exemplary record illustrated in FIG. 4, as can be seen certain performance settings may be rated “high,” “medium,” “low” or “none” for impact (power consumption vs. user experience) depending upon the target component. Based on historical sensor measurements and/or calculations including, but not limited to, ambient environment temperature, power rail measurements, processing component junction temperatures, and m/pl levels, the power performance module 101 may determine an adjustment to one or more performance settings. The module 101 may identify which one or more of the processing components is most thermally aggressive and, from there, select those performance setting knobs best positioned for adjustment, i.e., those performance settings knobs which may be adjusted down to provide the most impact on power consumption for the least cost on user experience or, alternatively, adjusted up to provide the least impact on power consumption for the most benefit to user experience.

For example, adjusting the eye buffer resolution may have a high impact on reducing power consumption by the GPU and the DRAM memory system (with minimal impact on user experience) while having essentially no impact on power consumption by the CPU. As such, in a given scenario wherein historical data indicates that there is a high risk of a thermal event if the DCVS 26 is set to the same maximum as previously set under the given use case, and the GPU is the most thermally aggressive active component in a VR use case, embodiments of the solution may elect to adjust down the eye buffer resolution instead of reducing the DCVS maximum set point, thereby reducing power consumption by the GPU (and, by extension, lowering thermal energy generation in the system) without affecting the ability of the CPU to efficiently process a time warp workload that directly affects the m/pl ratio.

Similarly, in a scenario wherein historical data indicates to the power performance module 101 that the risk of a thermal event is low if the DCVS 26 is set to the same maximum as previously set under the given use case, embodiments of the solution may elect to adjust up the textures level of detail, thereby modestly increasing power consumption by the GPU and memory 112 without affecting the CPU's ability to process its workloads or risking a thermal throttle event.

FIGS. 5A-5D illustrate exemplary profile graphs of an exemplary GPU processing component 182 for a given immersive multimedia use case, each illustrating a relationship between a performance setting, user experience relative to the setting, and power consumption associated with the setting. Profile graphs, or similarly indicative data, for each potentially thermally aggressive component in a system 102 may be stored in LUT 29 or simply measured in real-time by sensors 157 and provided to the power performance module 101 via the M&L module 114. As described above, the power performance module 101, in furtherance of its goal to optimize user experience without exceeding the thermal envelope of the PCD 110, may adjust performance settings of processing components based on historical settings in the given use case in order to deliver an optimized and sustained QoS over a duration of time.

Referring back to the example above relative to the description of record 400 in FIG. 4, in a given scenario wherein there is a high risk of a thermal event if the DCVS 26 maximum set point remains unchanged from the previous execution of the application per the given use case, and the GPU 182 is the most thermally aggressive active component in a VR use case, embodiments of the solution may elect to adjust down the eye buffer resolution, thereby reducing power consumption by the GPU 182 (and, by extension, lowering thermal energy generation in the system) without lowering the maximum power supply through the DCVS 26 and affecting the ability of the CPU to efficiently process a time warp workload that directly affects the m/pl ratio. Such election may be determined based on the performance setting graph illustrated in FIG. 5B, for example, which may be leveraged by the power performance module 101 to determine that the active setting of the eye buffer resolution may be reduced significantly, thereby saving power, without any significant impact on user experience and without having to lower the maximum set point allowed by the DCVS 26.

Notably, it will be understood that the profile graphs in FIG. 5 are representative of empirically collected data and, as such, may exist in a query table form in a memory component 112. As one of ordinary skill in the art would recognize, data instantiated in a table may be represented in a graphical form, such as shown in the FIG. 5 illustrations. Accordingly, for best understanding, the exemplary data of FIG. 5 are depicted and described as profile graphs to better visually illustrate the relationship of performance settings for active components (the GPU in the FIG. 5 illustrations) in a VR use case to a power consumption level and user experience.

Referring to FIG. 5A, moving left to right along the x-axis of the graph represents an increase in the power consumption required by the GPU 182 to process a VR workload portion attributable to time warp related chromatic aberration correction. As one of ordinary skill in the art will recognize, an increase in the time warp CAC setting requires an increase in the power consumed (which also correlates to an increase in thermal energy generation) by the GPU 182 processing component. That is, the more precise the time warp CAC setting, the higher the power level required in order to process its related workload. Accordingly, moving upward along the y-axis represents an increase in power consumption and the dashed line 10A represents the correlation between time warp CAC and power consumption, as is understood by one of ordinary skill in the art.

In the FIG. 5A graph, the y-axis may also represent a user experience (“Ux”) level where moving upward along the y-axis correlates with an improved Ux. Accordingly, as represented by the solid line curve 11A, there is a correlation between the time warp CAC setting and the Ux level. For the most part, as one of ordinary skill in the art will recognize, a more precise time warp CAC setting is favorable to a VR user over a lesser setting. Referring to the curve 11A, the initially steep slope of the curve 11A illustrates that an increase in the time warp CAC setting from a relatively low level may produce a significant increase in Ux. By contrast, the upper portion of the slope 11A which corresponds to higher time warp CAC setting illustrates that further increases in the setting will not produce noticeable increases in Ux levels once the time warp CAC setting is already relatively high. That is, the user may not notice or appreciate the increased time warp CAC setting level and, as such, an increase in the setting will only increase power consumption and will not improve Ux.

With the above in mind, one of ordinary skill in the art will recognize that an increase or decrease in the time warp CAC setting, when the time warp CAC setting is initially relatively low, will generate a larger impact on Ux per watt of power consumption than when the initial time warp CAC setting is initially relatively high. For example, the point 12A represents an exemplary initial time warp CAC setting that is neither high nor low, i.e. the GPU 182 is processing a portion of a VR workload associated with a moderate time warp CAC setting. As such, the slope of a tangent to curve 11A at point 12A indicates that an adjustment down in the time warp CAC setting will generate moderate power savings (thus saving moderate amounts of thermal energy generation) while moderately impacting Ux. Similarly, an adjustment up in the time warp CAC setting will require a moderate increase in power consumption (thus a moderate increase in thermal energy generation) while providing a positive, though moderate, impact on Ux.

Referring to FIG. 5B, moving left to right along the x-axis of the graph represents an increase in the power consumption required by the GPU 182 to process a VR workload portion attributable to eye buffer resolution. As one of ordinary skill in the art will recognize, an increase in the eye buffer resolution requires an increase in the power consumed (which also correlates to an increase in thermal energy generation) by the GPU component 182. Accordingly, moving upward along the y-axis represents an increase in power consumption and the dashed line 10B represents the correlation between the eye buffer resolution setting and power consumption, as is understood by one of ordinary skill in the art.

In the FIG. 5B graph, the y-axis may also represent a user experience (“Ux”) level where moving upward along the y-axis correlates with an improved Ux. Accordingly, as represented by the solid line curve 11B, there is a correlation between the eye buffer resolution setting and the Ux level. Referring to the curve 11B, the initially steep slope of the curve 11B illustrates that an increase in the eye buffer resolution setting from a relatively low level may produce a significant increase in Ux. By contrast, the flatter portion of the slope 11B which corresponds to higher eye buffer resolution settings illustrates that further increases in eye buffer resolution will not produce noticeable increases in Ux levels once the eye buffer resolution setting is already relatively high.

With the above in mind, one of ordinary skill in the art will recognize that an increase or decrease in the eye buffer resolution setting, when the setting is initially relatively low, will generate a larger impact on Ux per watt of power consumption than when the setting is initially relatively high. For example, the point 12B represents an exemplary initial eye buffer resolution setting that is relatively high, i.e. the GPU 182 is processing a portion of a VR workload associated with a high eye buffer resolution setting. As such, the slope of a tangent to curve 11B at point 12B is relatively flat and indicates that an adjustment down in the eye buffer resolution setting will generate power savings (thus lowering thermal energy generation) without significant impact to Ux. Similarly, an adjustment up in the eye buffer resolution setting will require increased power consumption (thus increased thermal energy generation) without a positive impact on Ux.

Referring to FIG. 5C, moving left to right along the x-axis of the graph represents an increase in the power consumption required by the GPU to process a VR workload portion attributable to eye buffer MSAA. As one of ordinary skill in the art will recognize, an increase in the eye buffer MSAA setting requires an increase in the power consumed (which also correlates to an increase in thermal energy generation) by the GPU 182. That is, the higher the eye buffer MSAA setting, the higher the power level required in order to process its related workload. Accordingly, moving upward along the y-axis represents an increase in power consumption and the dashed line 10C represents the correlation between processing capacity and power consumption, as is understood by one of ordinary skill in the art.

In the FIG. 5C graph, the y-axis may also represent a Ux level where moving upward along the y-axis correlates with an improved Ux. Accordingly, as represented by the solid line curve 11C, there is a correlation between the eye buffer MSAA setting and the Ux level. Referring to the curve 11C, the initially steep slope of the curve 11C illustrates that an increase in the eye buffer MSAA setting from a relatively low level may produce a significant increase in Ux. By contrast, the upper portion of the slope 11C which corresponds to higher eye buffer MSAA settings illustrates that further increases in the settings will not produce noticeable increases in Ux levels once the setting is already relatively high. That is, the user may not notice or appreciate the increased eye buffer MSAA setting and, as such, an increase will not improve Ux.

With the above in mind, one of ordinary skill in the art will recognize that an increase or decrease in the eye buffer MSAA setting, when the setting is initially relatively low, will generate a larger impact on Ux per watt of power consumption than when the initial setting is initially relatively high. For example, the point 12C represents an exemplary initial eye buffer MSAA setting that is relatively low. As such, the slope of a tangent to curve 11C at point 12C is relatively steep and indicates that an adjustment down in the eye buffer MSAA setting will generate little power savings (thus saving little thermal energy generation) while significantly impacting Ux detrimentally. Similarly, an adjustment up in the eye buffer MSAA setting will require only a small increase in power consumption (thus a small increase in thermal energy generation) while providing a significant and positive impact on Ux.

Referring to FIG. 5D, moving left to right along the x-axis of the graph represents an increase in the power consumption required by the GPU to process a VR workload portion attributable to eye buffer FPS. As one of ordinary skill in the art will recognize, an increase in the eye buffer FPS setting requires an increase in the power consumed (which also correlates to an increase in thermal energy generation) by the GPU 182 processing component. Accordingly, moving upward along the y-axis represents an increase in power consumption and the dashed line 10D represents the correlation between the eye buffer FPS setting and power consumption, as is understood by one of ordinary skill in the art.

In the FIG. 5D graph, the y-axis may also represent a user experience (“Ux”) level where moving upward along the y-axis correlates with an improved Ux. Accordingly, as represented by the solid line curve 11D, there is a correlation between the eye buffer FPS setting and the Ux level. Referring to the curve 11D, the initially steep slope of the curve 11D illustrates that an increase in the eye buffer FPS setting from a very low setting may produce a significant increase in Ux. By contrast, the flatter portion of the slope 11D which corresponds to moderate and high eye buffer FPS settings illustrates that further increases in the setting beyond relatively low levels will not produce noticeable increases in Ux levels.

With the above in mind, one of ordinary skill in the art will recognize that an increase or decrease in the eye buffer FPS setting, when the setting is initially very low, will generate a more appreciable impact on Ux per watt of power consumption than when the initial setting is initially relatively moderate or even high. For example, the point 12D represents an exemplary initial eye buffer FPS setting that is relatively high, i.e. the GPU 182 is processing a portion of a VR workload associated with a high eye buffer FPS setting. As such, the slope of a tangent to curve 11D at point 12D is relatively flat and indicates that an adjustment down in the eye buffer FPS setting will generate power savings (thus lowering thermal energy generation) without significant impact to Ux. Similarly, an adjustment up in the eye buffer FPS setting will require increased power consumption (thus increased thermal energy generation) with no noticeable impact on Ux.

Based on profile graph performance settings, embodiments of the system and method may systematically adjust one or more performance settings to optimize Ux in a VR use case while adjusting overall power consumption to avoid a thermal event. As a non-limiting example, the performance settings of the various components active according to a VR gaming use case collectively contribute to an overall Ux level and an overall power consumption level associated with the use case. As explained above, an increase or decrease in the active setting for any portion of the VR workload may affect both overall Ux and overall power consumption depending on which one or more processing components may be affected by the setting. Advantageously, in the event that power consumption should be increased or decreased, embodiments of the solution seek to make such power consumption adjustments (and, by extension, thermal energy generation adjustments) in a manner that optimizes Ux without causing a thermal event that could jeopardize a consistent, sustained performance.

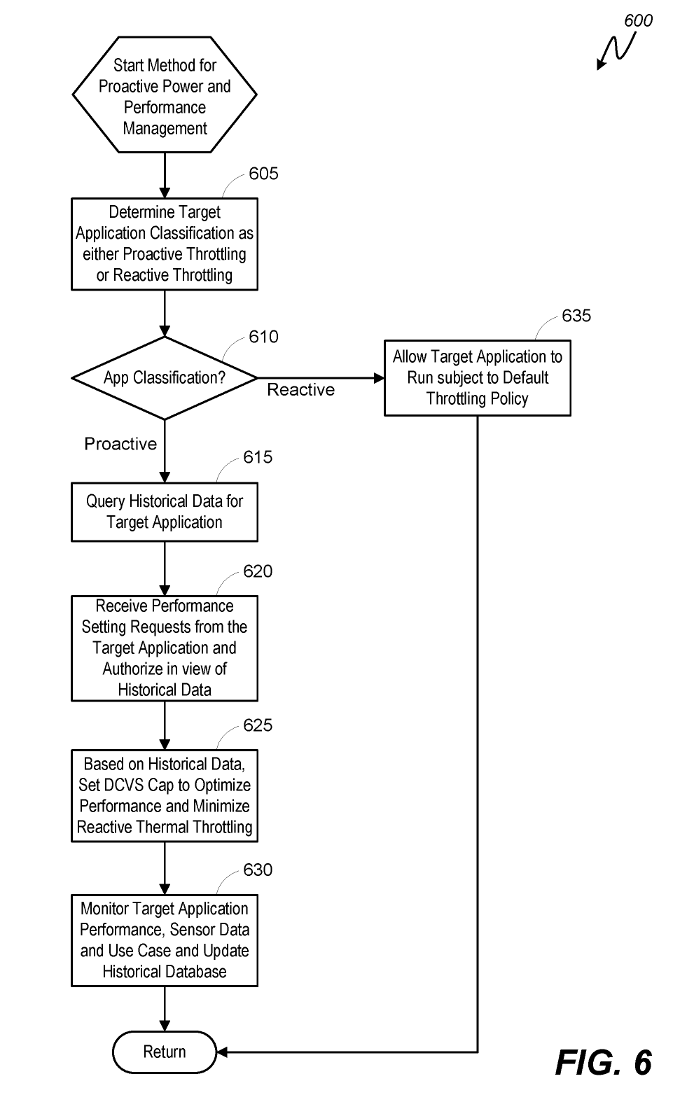

FIG. 6 depicts a logical flowchart illustrating a method 600 for proactive power and performance management in a portable computing device (“PCD”) via consideration of historical performance data and requests for selective adjustments of component performance settings to avoid frame drops and/or detrimental frame rate reduction. Beginning at block 605, the classification of the target application may be determined. It is envisioned that some applications, such as an immersive multimedia application, may be earmarked for proactive throttling as a result of user experience metrics indicating that a consistent, sustained performance is more desirable than intermittent performance at a maximum processing speed. Immersive multimedia applications may be a good example of applications that would be better served by a proactive throttling policy that ensures a sustained FPS over a long period of time than a reactive throttling policy that swings processing performance in reaction to thermal events.

Returning to the method 600, at decision block 610 if the target application is determined to be compatible with a reactive thermal throttling policy, i.e. the target application benefits more from intermittent maximum processing speeds than it suffers from thermal throttling actions, then the “reactive” branch is followed to block 635. At block 635, the target application is allowed to run subject to a default, reactive thermal throttling policy and the method returns.

If, however, at decision block 610 the target application is determined to be compatible with a proactive thermal throttling policy, i.e., the target application benefits more from a sustained performance than from an intermittent maximum performance, then the “proactive” branch is followed to block 615. At block 615, the LUT 29 may be queried for historical data for the application when executed according to the same, or similar, use case under which it is about to be executed. Advantageously, the M&L module 114 may have recorded any number of data that collectively may be used to define a use case(s) for the application including, but not limited to, temperature readings, concurrent workloads, thermal throttling actions, clock boost requests, processor performance settings, maximum or capped DCVS settings, etc.

Next, at block 620, the power and performance manager 101 may receive inputs or requests from the application for certain performance settings or quality level settings. The power performance manager 101, in view of the historical data queried at 615, may authorize or decline the requested performance settings. For example, based on the last time the application was executed per the given use case, the power performance manager 101 may determine that the maximum DCVS set point was a little high, thereby allowing for the occasional thermal event and throttling action, and decide that it would be better to reduce one or more performance settings, and lower user visual output quality a little, in an effort to avoid reducing the DCVS set point.

The method continues to block 625 and the power performance module 101 sets or caps the DCVS maximum power setting in view of the historical data and/or the performance settings of the processing components. The DCVS set point is set in view of the historical data in an effort to ensure a consistent, sustained performance with few, or no, thermal throttling events. The method 600 continues to block 630 where the M&L module 114 monitors the behavior of the target application, particularly the nature and number of thermal throttling events, and the use case indicators (current sensor readings, temperature readings, concurrent workloads, etc.) in order to update the historical database for future executions of the application. The method 600 returns.

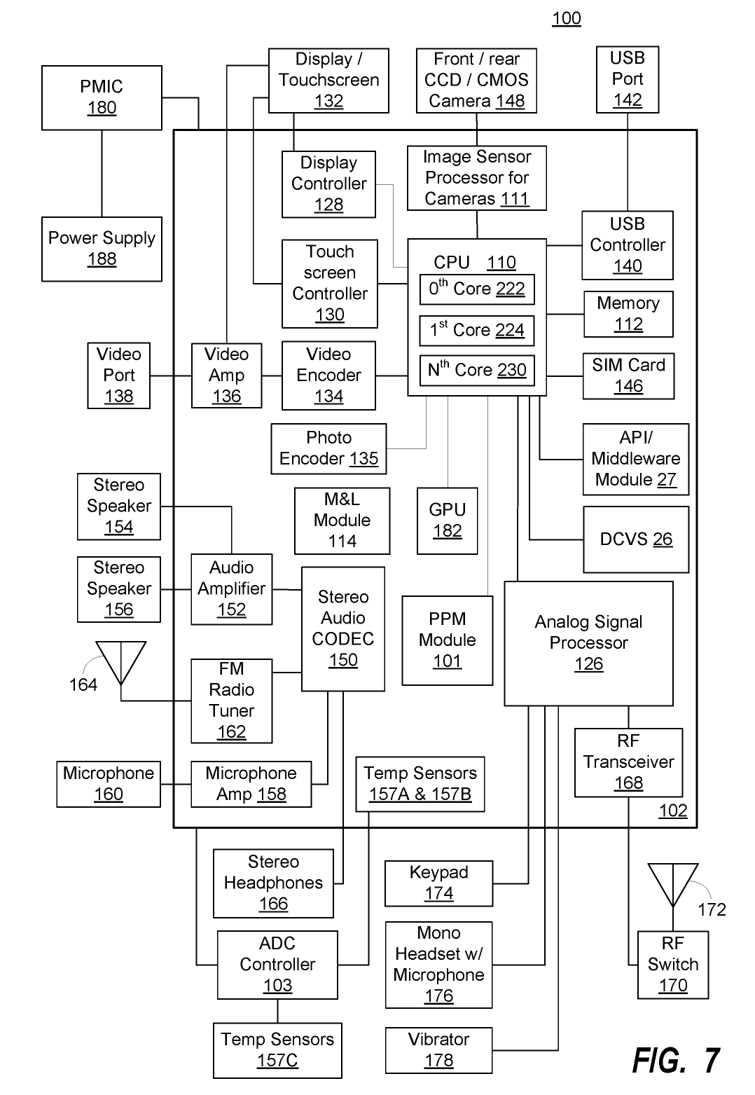

FIG. 7 is a functional block diagram illustrating an exemplary, non-limiting aspect of the PCD of FIGS. 1 and 3 in the form of a wireless telephone for implementing methods and systems for proactive power and performance management. As shown, the PCD 100 includes an on-chip system 102 that includes a multi-core central processing unit (“CPU”) 110 and an analog signal processor 126 that are coupled together. The CPU 110 may comprise a zeroth core 222, a first core 224, and an Nth core 230 as understood by one of ordinary skill in the art. Further, instead of a CPU 110, a digital signal processor (“DSP”) may also be employed as understood by one of ordinary skill in the art.

In general, the M&L module 114, API/Middleware module 27 and PPM module 101 may be collectively responsible for setting DCVS 26 maximum set points and selecting and making adjustments to performance settings associated with active processing components according to a given VR use case, such as GPU 182, such that power consumption (and, by extension, thermal energy generation) is managed and user experience for the immersive multimedia use case is optimized.

The M&L module 114 may communicate with multiple operational sensors (e.g., thermal sensors, power sensors 157A, 157B) distributed throughout the on-chip system 102 and with the CPU 110 of the PCD 100 as well as with the PPM module 101. In some embodiments, M&L module 114 may also monitor skin temperature sensors 157C for temperature readings associated with a touch temperature and/or ambient temperature of PCD 100. In other embodiments, M&L module 114 may infer touch temperatures based on a likely delta with readings taken by on-chip temperature sensors 157. The PPM module 101 may work with the L&M module 114 to identify temperature thresholds and/or power budgets that could be exceeded and instruct the application of performance settings 28 adjustments associated with power consuming components within chip 102 in an effort to avoid a thermal event without unnecessarily impacting user experience for the immersive multimedia use case.

As illustrated in FIG. 7, a display controller 128 and a touch screen controller 130 are coupled to the digital signal processor 110. A touch screen display 132 external to the on-chip system 102 is coupled to the display controller 128 and the touch screen controller 130. PCD 100 may further include a video encoder 134, e.g., a phase-alternating line (“PAL”) encoder, a sequential couleur avec memoire (“SECAM”) encoder, a national television system(s) committee (“NTSC”) encoder or any other type of video encoder 134. The video encoder 134 is coupled to the multi-core central processing unit (“CPU”) 110. A video amplifier 136 is coupled to the video encoder 134 and the touch screen display 132. A video port 138 is coupled to the video amplifier 136. As depicted in FIG. 7, a universal serial bus (“USB”) controller 140 is coupled to the CPU 110. Also, a USB port 142 is coupled to the USB controller 140. A memory 112 and a subscriber identity module (SIM) card 146 may also be coupled to the CPU 110. Further, as shown in FIG. 7, a digital camera 148 may be coupled to the CPU 110. In an exemplary aspect, the digital camera 148 is a charge-coupled device (“CCD”) camera or a complementary metal-oxide semiconductor (“CMOS”) camera.

As further illustrated in FIG. 7, a stereo audio CODEC 150 may be coupled to the analog signal processor 126. Moreover, an audio amplifier 152 may be coupled to the stereo audio CODEC 150. In an exemplary aspect, a first stereo speaker 154 and a second stereo speaker 156 are coupled to the audio amplifier 152. FIG. 7 shows that a microphone amplifier 158 may also be coupled to the stereo audio CODEC 150. Additionally, a microphone 160 may be coupled to the microphone amplifier 158. In a particular aspect, a frequency modulation (“FM”) radio tuner 162 may be coupled to the stereo audio CODEC 150. Also, an FM antenna 164 is coupled to the FM radio tuner 162. Further, stereo headphones 166 may be coupled to the stereo audio CODEC 150.

FIG. 7 further indicates that a radio frequency (“RF”) transceiver 168 may be coupled to the analog signal processor 126. An RF switch 170 may be coupled to the RF transceiver 168 and an RF antenna 172. As shown in FIG. 7, a keypad 174 may be coupled to the analog signal processor 126. Also, a mono headset with a microphone 176 may be coupled to the analog signal processor 126. Further, a vibrator device 178 may be coupled to the analog signal processor 126. FIG. 7 also shows that a power supply 188, for example a battery, is coupled to the on-chip system 102 through power management integrated circuit (“PMIC”) 180. In a particular aspect, the power supply includes a rechargeable DC battery or a DC power supply that is derived from an alternating current (“AC”) to DC transformer that is connected to an AC power source.

The CPU 110 may also be coupled to one or more internal, on-chip thermal sensors 157A as well as one or more external, off-chip thermal sensors 157C. The on-chip thermal sensors 157A may comprise one or more proportional to absolute temperature (“PTAT”) temperature sensors that are based on vertical PNP structure and are usually dedicated to complementary metal oxide semiconductor (“CMOS”) very large-scale integration (“VLSI”) circuits. The off-chip thermal sensors 157C may comprise one or more thermistors. The thermal sensors 157C may produce a voltage drop that is converted to digital signals with an analog-to-digital converter (“ADC”) controller 103. However, other types of thermal sensors 157A, 157C may be employed without departing from the scope of the invention.

The M&L module(s) 114 and/or PPM module(s) 101 may comprise software which is executed by the CPU 110. However, the M&L module(s) 114 and/or PPM module(s) 101 may also be formed from hardware and/or firmware without departing from the scope of the invention. The M&L module(s) 114 and/or PPM module(s) 101 may be collectively responsible for implementing proactive throttling strategies in a given VR use case such that power consumption (and, by extension, thermal energy generation) is managed to avoid frame drops or reduction in FPS rates and user experience is optimized.

The touch screen display 132, the video port 138, the USB port 142, the camera 148, the first stereo speaker 154, the second stereo speaker 156, the microphone 160, the FM antenna 164, the stereo headphones 166, the RF switch 170, the RF antenna 172, the keypad 174, the mono headset 176, the vibrator 178, the power supply 188, the PMIC 180 and the thermal sensors 157C are external to the on-chip system 102. However, it should be understood that the M&L module 114 may also receive one or more indications or signals from one or more of these external devices by way of the analog signal processor 126 and the CPU 110 to aid in the real time management of the resources operable on the PCD 100.

In a particular aspect, one or more of the method steps described herein may be implemented by executable instructions and parameters stored in the memory 112 that form the one or more M&L module(s) 114 and/or PPM module(s) 101. These instructions that form the module(s) 101, 114 may be executed by the CPU 110, the analog signal processor 126, or another processor, in addition to the ADC controller 103 to perform the methods described herein. Further, the processors 110, 126, the memory 112, the instructions stored therein, or a combination thereof may serve as a means for performing one or more of the method steps described herein.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the drawings, which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Therefore, although selected aspects have been illustrated and described in detail, it will be understood that various substitutions and alterations may be made therein without departing from the spirit and scope of the present invention, as defined by the following claims.

What is claimed is:

1. A method for proactive power and performance management in a portable computing device (“PCD”), the method comprising:
determining that a first target application is compatible with a proactive throttling policy;
determining a first active use case associated with the first target application;
querying a historical database for performance data associated with the first target application when previously executed according to a previous use case that is similar to the first active use case;
based on the queried performance data, determining performance settings for one or more processing components, wherein the performance settings are determined in view of a goal to minimize thermally triggered throttling;
executing the first target application subject to the determined performance settings;
monitoring the first target application operating per the first active use case; and
updating the historical database to include updated performance data for the first target application when executed in association with the first active use case.

2. The method of claim 1, wherein the first target application comprises an immersive multimedia workload.

3. The method of claim 1, further comprising:
recognizing that a second target application is queued for execution;
determining that the second active use case is compatible with a reactive throttling policy; and
allowing the second target application to execute subject to a default throttling policy, wherein the default throttling policy adjusts performance settings for the one or more processing components in view of real-time thermal energy readings.

4. The method of claim 1, wherein the first active use case is determined based on readings from one or more thermal sensors, wherein the one or more thermal sensors indicate thermal energy generation in the PCD.

5. The method of claim 1, wherein the first active use case is determined based on readings from one or more current sensors, wherein the one or more current sensors monitor power levels on one or more power rails supplying the one or more processing components.

6. The method of claim 1, wherein the determined performance settings comprise a cap to a dynamic control and voltage setting for power supplied to the one or more processing components.

7. The method of claim 1, wherein the determined performance settings comprise adjustments to workload settings associated with a visual output quality.

8. The method of claim 1, wherein the PCD is in the form of a wireless telephone.

9. A computer system for proactive power and performance management in a portable computing device (“PCD”), the system comprising:
a power performance manager module, a monitoring and learning module (“M&L”), a database, and a dynamic control and voltage scaling module collectively configured to:
determine that a first target application is compatible with a proactive throttling policy;
determine a first active use case associated with the first target application;
query the historical database for performance data associated with the first target application when previously executed according to a previous use case that is similar to the first active use case;
based on the queried performance data, determine performance settings for one or more processing components, wherein the performance settings are determined in view of a goal to minimize thermally triggered throttling;
execute the first target application subject to the determined performance settings;
monitor the first target application operating per the first active use case; and
update the historical database to include updated performance data for the first target application when executed in association with the first active use case.

10. The system of claim 9, wherein the first target application comprises an immersive multimedia workload.

11. The system of claim 9, wherein the power performance manager module, the monitoring and learning module (“M&L”), the database, and the dynamic control and voltage scaling module collectively are further configured to:
recognize that a second target application is queued for execution;
determine that the second active use case is compatible with a reactive throttling policy; and
allow the second target application to execute subject to a default throttling policy, wherein the default throttling policy adjusts performance settings for the one or more processing components in view of real-time thermal energy readings.

12. The system of claim 9, wherein the first active use case is determined based on readings from one or more thermal sensors, wherein the one or more thermal sensors indicate thermal energy generation in the PCD.

13. The system of claim 9, wherein the first active use case is determined based on readings from one or more current sensors, wherein the one or more current sensors monitor power levels on one or more power rails supplying the one or more processing components.

14. The system of claim 9, wherein the determined performance settings comprise a cap to a dynamic control and voltage setting for power supplied to the one or more processing components.

15. The system of claim 9, wherein the determined performance settings comprise adjustments to workload settings associated with a visual output quality.

16. The system of claim 9, wherein the PCD is in the form of a wireless telephone.

17. A computer system for proactive power and performance management in a portable computing device (“PCD”), the system comprising:
means for determining that a first target application is compatible with a proactive throttling policy;
means for determining a first active use case associated with the first target application;
means for querying a historical database for performance data associated with the first target application when previously executed according to a previous use case that is similar to the first active use case;
means for, based on the queried performance data, determining performance settings for one or more processing components, wherein the performance settings are determined in view of a goal to minimize thermally triggered throttling;
means for executing the first target application subject to the determined performance settings;
means for monitoring the first target application operating per the first active use case; and
means for updating the historical database to include updated performance data for the first target application when executed in association with the first active use case.

18. The computer system of claim 17, wherein the first target application comprises an immersive multimedia workload.

19. The computer system of claim 17, further comprising:
means for recognizing that a second target application is queued for execution;
means for determining that the second active use case is compatible with a reactive throttling policy; and
means for allowing the second target application to execute subject to a default throttling policy, wherein the default throttling policy adjusts performance settings for the one or more processing components in view of real-time thermal energy readings.

20. The computer system of claim 17, wherein the first active use case is determined based on readings from one or more thermal sensors, wherein the one or more thermal sensors indicate thermal energy generation in the PCD.

21. The computer system of claim 17, wherein the first active use case is determined based on readings from one or more current sensors, wherein the one or more current sensors monitor power levels on one or more power rails supplying the one or more processing components.

22. The computer system of claim 17, wherein the determined performance settings comprise a cap to a dynamic control and voltage setting for power supplied to the one or more processing components.

23. The computer system of claim 17, wherein the determined performance settings comprise adjustments to workload settings associated with a visual output quality.

24. A computer program product comprising a computer usable device having a computer readable program code embodied therein, said computer readable program code adapted to be executed to implement a method for proactive power and performance management in a portable computing device (“PCD”), said method comprising:
determining that a first target application is compatible with a proactive throttling policy;
determining a first active use case associated with the first target application;
querying a historical database for performance data associated with the first target application when previously executed according to a previous use case that is similar to the first active use case;
based on the queried performance data, determining performance settings for one or more processing components, wherein the performance settings are determined in view of a goal to minimize thermally triggered throttling;
executing the first target application subject to the determined performance settings;
monitoring the first target application operating per the first active use case; and
updating the historical database to include updated performance data for the first target application when executed in association with the first active use case.

25. The computer program product of claim 24, wherein the first target application comprises an immersive multimedia workload.

26. The computer program product of claim 24, further comprising:
recognizing that a second target application is queued for execution;
determining that the second active use case is compatible with a reactive throttling policy; and
allowing the second target application to execute subject to a default throttling policy, wherein the default throttling policy adjusts performance settings for the one or more processing components in view of real-time thermal energy readings.

27. The computer program product of claim 24, wherein the first active use case is determined based on readings from one or more thermal sensors, wherein the one or more thermal sensors indicate thermal energy generation in the PCD.

28. The computer program product of claim 24, wherein the first active use case is determined based on readings from one or more current sensors, wherein the one or more current sensors monitor power levels on one or more power rails supplying the one or more processing components.

29. The computer program product of claim 24, wherein the determined performance settings comprise a cap to a dynamic control and voltage setting for power supplied to the one or more processing components.

30. The computer program product of claim 24, wherein the determined performance settings comprise adjustments to workload settings associated with a visual output quality.
